(19) United States
(12) Patent Application Publication
(10) Pub. No.: US 2021/0362882 A1
(43) Pub. Date: Nov. 25, 2021

(54) System and Method for Washing and De-icing Aircrafts

(71) Applicant: MSG Production AS, Skien (NO)

(72) Inventor: Svein Gunnar Mæland, Telemark (NO)

(21) Appl. No.: 17/196,290

(22) Filed: Mar. 9, 2021

Related U.S. Application Data
(63) Continuation-in-part of application No. 15/283,679, filed on Oct. 3, 2016, now Pat. No. 10,940,509.

(51) Int. Cl. B64F 5/30; B64D 15/10; B64D 15/22; B08B 13/00; B08B 3/02; G01B 11/00; G01B 11/24

(52) U.S. Cl. CPC B64F 5/30; B64D 15/10; B64D 15/22; G01B 11/24; B08B 3/024; G01B 11/002; B08B 13/00

(57) ABSTRACT

The present discloses a system for washing and de-icing of aircrafts. The preset invention provides a washing and deicing area comprising one or more gantries to ensure different steps of the washing or the de-icing process. The structure of the one or more gantries is essentially made of telescopic arms allowing more flexibility on the positioning of nozzle clusters during the washing and de-icing process. The use of such a mechanical system is easily accommodated to different aircraft bodies regardless their sizes. The whole functionality and positioning of the system is ensured by a programmable system comprising an aircraft position detection system and an aircraft contour detection system allowing the programmable system to reposition the nozzle clusters in a preferred location while avoiding contact with the aircraft.

### CROSS-REFERENCE TO RELATED APPLICATIONS

The present patent application is a Continuation-in-Part of U.S. patent application Ser. No. 15/283,679, entitled “SYSTEM AND METHOD FOR WASHING AND DE-ICING AIRCRAFTS”, and filed at the United States Patent Office on Oct. 3, 2016, the content of which is incorporated herein by reference.

### FIELD OF THE INVENTION

The present invention generally relates to a system and methods for washing and de-icing aircrafts. More specifically, the present invention relates to systems and methods for washing and de-icing aircrafts within a closed area.

### BACKGROUND OF THE INVENTION

The surface smoothness of the supporting surfaces of an aircraft is considered as one of the major factors defining the aerodynamic characteristics of an aircraft. Rough surfaces increase air drag which may deteriorate the flying performance to a considerable degree and increases the fuel consumption. During flight the built-in de-icing system of the aircraft is sufficient but at ground intervals de-icing must be performed before start under unfavorable meteorological conditions.

Conventionally, de-icing and washing systems for aircrafts were hand operated. The spraying of the de-icing liquid is generally performed by a team of operators. Such a de-icing process substantially relies on the skill of the operator, good visibility and a thorough examination of the aircraft which may lead to an incomplete de-icing process before take-off of the airplane. Improper de-icing results in ice formation on control surfaces causing a total loss or at least a substantial loss of stability and flight control. Furthermore, de-icing fluid should not be applied in the non-spraying zone, such as engines, windows or undercarriage. A hand-operated spraying doesn't guarantee to avoid such events. Meanwhile, the automatization of de-icing aims at preventing dramatic and/or disastrous effects on aircraft flight performance.

Typically, the total costs of a hand-operated de-icing can be separated into operating costs in the form of staff costs, cost of material and other costs of operation and traffic costs for the aircraft treated.

For some safety issues during the de-icing process, a general prior art solution is to keep operators and trucks further away from the aircraft. Such a solution induces more waste of de-icing fluid which causes a higher environmental contamination.

Furthermore, an automated de-icing system disclosed in U.S. Pat. No. 4,378,755, comprised a stationary gantry with stationary frames in an open environment. Such a system is affected by wind which requires a complex programmed system to place sensors or light beams to detect the wind strength.

### SUMMARY OF THE INVENTION

The aforesaid and other objectives of the present invention are realized by generally providing a system and a method for washing and de-icing aircrafts within an enclosure and using a controller.

The automated system according to the present invention aims at reducing total costs than previous methods by reducing staff training costs to a minimum. The system aims at avoiding delays in the traffic program of airports by reducing the de-icing time to a third of the actual time and aims at avoiding collisions between the aircraft and a truck, thus aiming at reducing the traffic costs.

In another aspect of the invention, the automated system according to the present invention aims at increasing flexibility to change the positioning of the de-icing and washing system depending on the size and shape of the aircraft, keeping a constant amount of used de-icing liquid.

In another aspect of the invention, the system comprises a closed hangar. Such closed hangar aims at increasing safety of the solution, at avoiding complex programmed systems and at eliminating or at least substantially reducing the wind problem.

Besides the common automated de-icing system, such as the system previously disclosed in U.S. Pat. No. 4,378,755, the present invention presents a washing system which aims at improving flight performance and fuel consumption of aircraft. Such a washing system is efficient to clean all kind of surface deposits which prevents surface corrosion and improves surface smoothness.

In a first aspect of the invention, a system for washing and de-icing of an aircraft is provided. The system comprises a hangar having a base, at least one transverse frame; each transverse frame comprising at least one automated vertical elongated members adapted to move vertically, each vertical elongated member being connected to a transversal member, spray means attached to the transversal members and adapted to spray liquid below the transversal member, a controller configured to control movement of the elongated members and configured to control the spray means, a guiding mean or system for taxying or moving the aircraft adapted to be removably attached to the aircraft, to move the aircraft under the transverse frames of the hangar and to measure or communicate position of an aircraft moving system, such as a spacer, to the controller. The system further comprises at least one tank for storing fluid for washing and de-icing, the tank being in fluid communication with the spray means.

In another aspect of the invention, the transversal member may be automated and may be adapted to transversally extend and collapse, the controller being further configured to control the extension and collapsing of the transversal member. The system may further comprise a first, second and third transversal frames, the second transversal frame being adapted to move parallel to the movement of the guiding means.

In a further aspect of the invention, the vertical elongated members may be telescopic arms, the spray means may be embodied as at least one nozzle or the spray means may be embodied as at least one flush board.

In another aspect of the invention, the system may further comprise a cabin for receiving an operator.

In yet another aspect of the invention, the controller may be further configured to receive specifications of the aircraft and to control the system with regard to the specifications of the aircraft or the controller may be further configured to receive current environmental conditions and to control the system with regard to the current environmental conditions.

In a further aspect of the invention, the base of the hangar may comprise guiding rails, the guiding mean may be a spacer unit adapted to be guided by the guiding rails or the base of the hangar may comprise spray means adapted to spray fluid under the aircraft.

In another aspect of the invention, the transversal member may comprise proximity sensors configured to communicate a signal based on the distance between the transversal member and the aircraft or each transversal member may comprise a plurality of sections, each section being pivotally connected to each end of the transversal member and each comprising at least one spray mean.

The present invention also provides a method for washing and de-icing an aircraft. The method comprises attaching the aircraft to a guiding mean, using the guiding mean to move the aircraft with a hangar comprising at least one transversal frame, as the aircraft moves toward a first transversal frame comprising vertical elongated arms, moving the vertical elongated arms over the aircraft body or wings without touching the aircraft, activating a first means to spray a fluid, the spray means being attached to transversal members, the transversal member being attached to one end of the elongated arms and detaching the guiding mean from the aircraft.

In another aspect of the invention, the method may further comprise communicating the position of the guiding means to a controller and controlling the movement of the vertical elongated arms and the activation of the first and second spray means using a controller based on the position received from the guiding means.

In yet another aspect of the invention, the method may further comprise communicating specifications of the aircraft and environmental conditions to the controller, changing concentration of the fluid based on the environmental conditions and further controlling the movement of the vertical elongated arms and the activation of the first and second spray means using a controller based on the specifications of the aircraft.

In a further aspect of the invention, the hangar may comprise two transversal frames. The method then further comprises as the aircraft moves toward a second transversal frame comprising second vertical elongated arms, moving the second vertical elongated arms over the aircraft body or wings without touching the aircraft and activating a second means to spray a fluid, the spray means being attached to second transversal members, the second transversal member being attached to one end of the second elongated arms.

In another aspect of the invention, the method further comprises, as the aircraft is moving toward a third transversal frame, being central among the other transversal frames, which comprises third vertical elongated arms, moving the third vertical elongated arms over the aircraft body or wings without touching the aircraft, moving the third central transversal frame along the length of the aircraft and inspecting quality of fluid sprayed on the aircraft.

In a further aspect of the invention, a system for washing and de-icing an aircraft is provided. The system comprises a hangar having a base, at least one transversal frame, each transversal frame comprising at least one automated vertical elongated member adapted to move vertically, each vertical elongated member being connected to a transversal member, a spraying system comprising at least one nozzle, the spraying system being attached to the at least one transversal member and adapted to disperse liquid below the transversal member, an over-the-air aircraft position detector to determine the position of the aircraft anywhere in the hangar, an aircraft contour detector configured to identify the shape and dimensions of the aircraft and a controller in communication with the aircraft position detector and with the aircraft contour detector. The controller is programmed to receive the detected position of the aircraft and the detected shape and dimensions information of the aircraft, control movement of the at least one automated vertical elongated member and to control activation of the spraying system, wherein the controller uses the received detected position of the aircraft and the detected shape and dimensions of the aircraft to automatically synchronize the movement of the automated vertical elongated member to conform with the shape and dimensions of the aircraft and automatically activate the spraying system up positioning of the automated vertical elongated member.

The system may comprise at least one static reference point fixed at a predetermined location in the hangar, the static reference point being detectable by the aircraft position detector. The aircraft position detector may be configured to detect the position of the at least one static reference point in relation to the aircraft position detector. The aircraft position detector may comprise one or more laser scanners. The one or more laser scanners may be fixed to be positioned over the aircraft.

The aircraft contour detector may comprise one or more laser scanners. The aircraft position detector and the aircraft contour detector may be unitary. The at least one of the aircraft position detector and the aircraft shape detector may be affixed to the hangar.

In yet another aspect of the invention, a system for washing and de-icing an aircraft is provided. The system comprises a hangar having a base, at least one transversal frame, each transversal frame comprising at least one automated vertical elongated member adapted to move vertically, each vertical elongated member being connected to a transversal member, a spraying system comprising at least one nozzle, the spraying system being attached to the at least one transversal member and adapted to disperse liquid below the transversal member, a three-dimensional (3D) aircraft scanner within a line of sight of the aircraft, the aircraft scanner being configured to identify a position of the aircraft anywhere in the hangar and a controller in communication with the aircraft scanner. The controller is programmed to receive the detected position of the aircraft from the aircraft scanner control movement of the at least one automated vertical elongated member and to control activation of the spraying system and using the received position of the aircraft and shape and dimensions of the aircraft to automatically synchronize the movement of the automated vertical elongated member to conform with the shape and dimensions of the aircraft and automatically activate the spraying system up positioning of the automated vertical elongated member.

The aircraft scanner may be a laser scanner. The system may comprise at least one static reference point fixed at a predetermined location in the hangar, the static reference point being detectable by the aircraft scanner. The aircraft scanner may be configured to detect the position of the at least one static reference point in relation to the aircraft scanner. The aircraft scanner may be further configured to determine a height, length and wingspan of the aircraft.

In a further aspect of the invention, a method for washing and de-icing an aircraft is provided. The method comprises moving the aircraft within a washing and de-icing area, automatically detecting a position of the aircraft, automatically detecting a contour of the aircraft, synchronously positioning at least one automated vertical elongated member based on the detected position and on the detected contour of the aircraft and activating a spraying system upon positioning of the at least one automated vertical elongated member.

Automatically detecting the position of the aircraft may comprise scanning the aircraft to obtain a three-dimensional map of the aircraft. Obtaining the three-dimensional map of the aircraft may comprise creating point cloud of the aircraft, calculating reference values of the point cloud in a coordinate system of the washing and de-icing area and deriving the position of the aircraft using the reference values.

The calculation of the reference values may comprise determining relative position of a scanning device to fixed reference points in the washing and de-icing area.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective exterior view of a hangar in accordance with the principles of the present invention.

FIG. 2 is a perspective inner view of the hangar of FIG. 1 showing a de-icing and washing system in accordance with the principles of the present invention.

FIG. 3 is a frontal inner view of the hangar of FIG. 1 showing the de-icing and washing system in accordance with the principles of the present invention.

FIG. 4 is a frontal inner view of the hangar of FIG. 1 showing an under flush system in accordance with the principles of the present invention

FIG. 5 is a frontal view of a part of a gantry showing a part of telescopic arms in accordance with the principles of the present invention

FIG. 6 is a close frontal view of the bottom part of the gantry showing the attach of telescopic arms in accordance with the principles of the present invention

FIG. 7 is a close frontal view showing an exemplary system of flush boards and nozzle clusters supported by the horizontal telescopic arm in accordance with the principles of the present invention.

FIG. 8 is a side view showing an exemplary system a nozzle clusters in accordance with the principles of the present invention.

FIG. 9 is a general perspective inner view of the hangar of FIG. 1 showing a first step of the de-icing and washing process in accordance with the principles of the present invention.

FIG. 10 is a general perspective inner view of the hangar of FIG. 1 showing a second step of the de-icing and washing process in accordance with the principles of the present invention.

FIG. 11 is a general perspective inner view of the hangar of FIG. 1 showing a third step of the de-icing and washing process in accordance with the principles of the present invention.

FIG. 12 is a general perspective inner view of the hangar of FIG. 1 showing a fourth step of the de-icing and washing process in accordance with the principles of the present invention.

FIG. 13 is a general perspective inner view of the hangar of FIG. 1 showing a fifth step of the de-icing and washing process in accordance with the principles of the present invention.

FIG. 14 a frontal inner view of an embodiment of a system for washing and de-icing an aircraft comprising an aircraft detection system in accordance with the principles of the present invention.

FIG. 15 is a flow chart diagram of an embodiment of a method for determining the position of an aircraft in accordance with the principles of the present invention.

### DETAILED DESCRIPTION OF THE PREFERRED EMBODIMENT

A novel system and method for washing and de-icing aircrafts will be described hereinafter. Although the invention is described in terms of specific illustrative embodiment(s), it is to be understood that the embodiment(s) described herein are by way of example only and that the scope of the invention is not intended to be limited thereby.

The system for washing and de-icing 200 typically comprises two modes of operation, the first mode being the washing of aircrafts and the second mode being the de-icing of aircrafts. Indeed, the washing and de-icing processes are used in non-complementary conditions as the de-icing is used in cold temperatures and the washing is used in warm conditions.

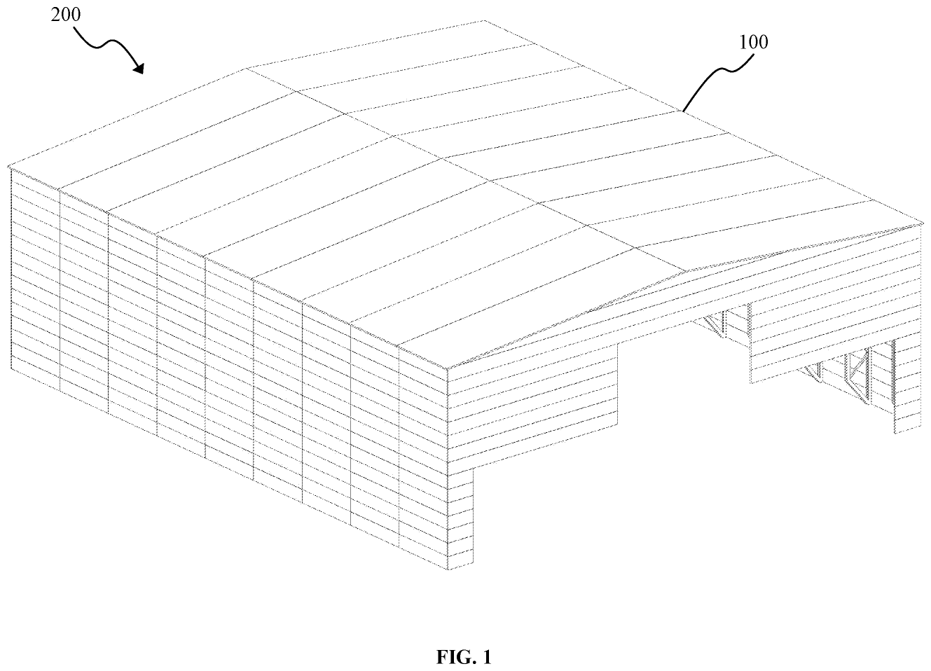

FIG. 1 illustrates a possible, but not restrictive, exterior structure of a hangar 100 providing a sufficient protection from meteorological conditions being unfavorable to washing and/or de-icing of aircrafts. In a preferred embodiment, the hangar 100 comprises wind curtains or doors to keep the washing and/or de-icing process within an enclosed environment. Understandably, in other embodiments, any other shape suitable to receive a plane may be used for the hangar 100. Furthermore, the hangar 100 may be built using any material sustaining meteorological environment, such as but not limited to, tarp, wood, cement, metal or any other suitable material. In yet other embodiments, the hangar 100 may be omitted.

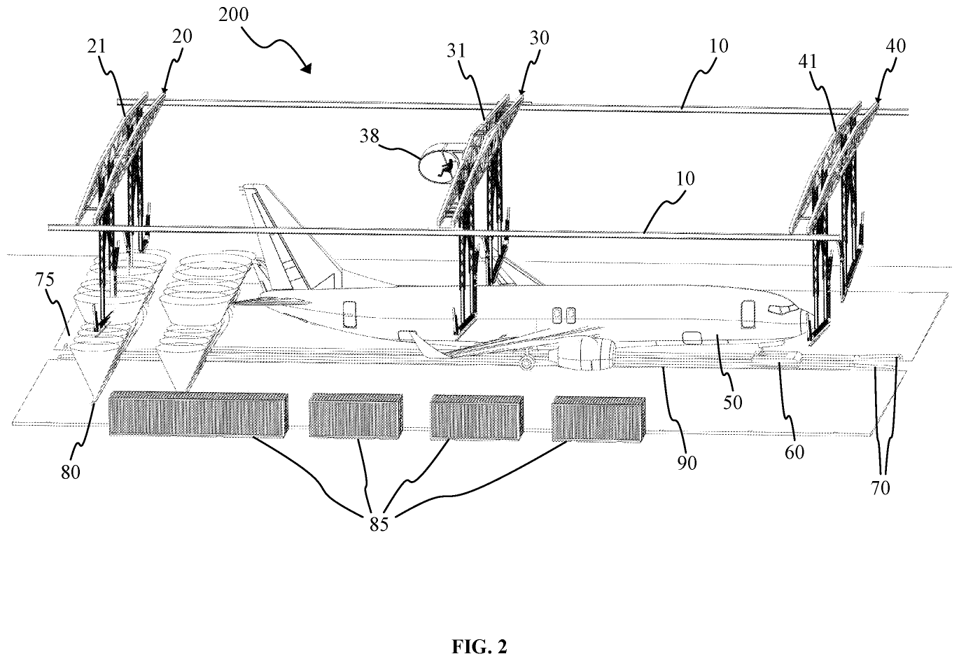

Now referring to FIGS. 2 to 4, a preferred embodiment of a system for washing and de-icing aircrafts 200 is illustrated. The de-icing and washing system 200 comprises three transverse frame members or gantries, 20, 30 and 40. In a preferred embodiment, the second transverse frame member may be moved along the length of the aircraft 50. Understandably, the system 200 comprising three gantries 20, 30 and 40 is shown to exemplify the invention. One skilled in the art shall understand that other embodiments could use only one frame member, two frame members or more than 3 frame members.

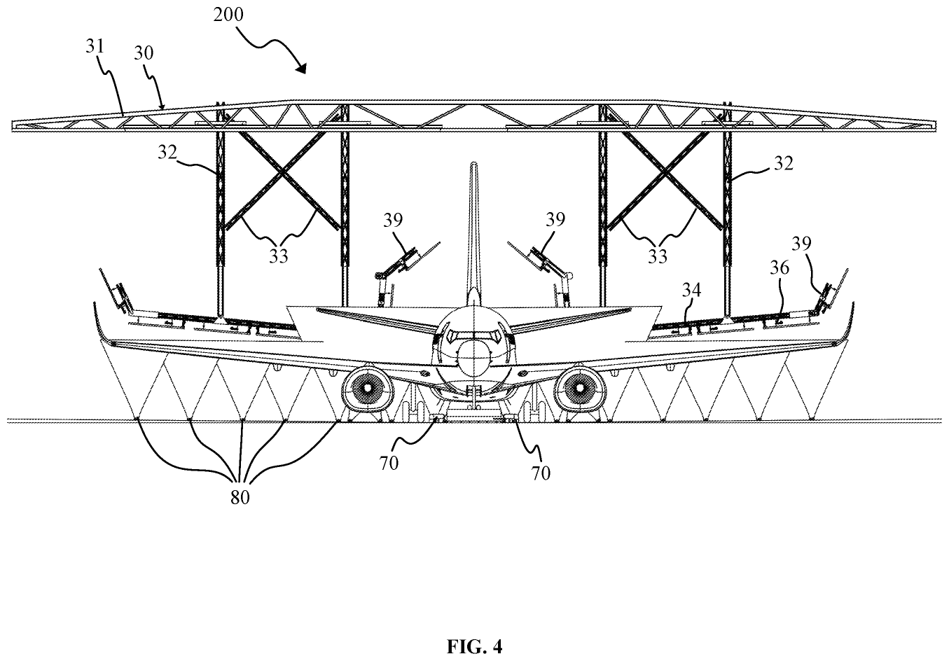

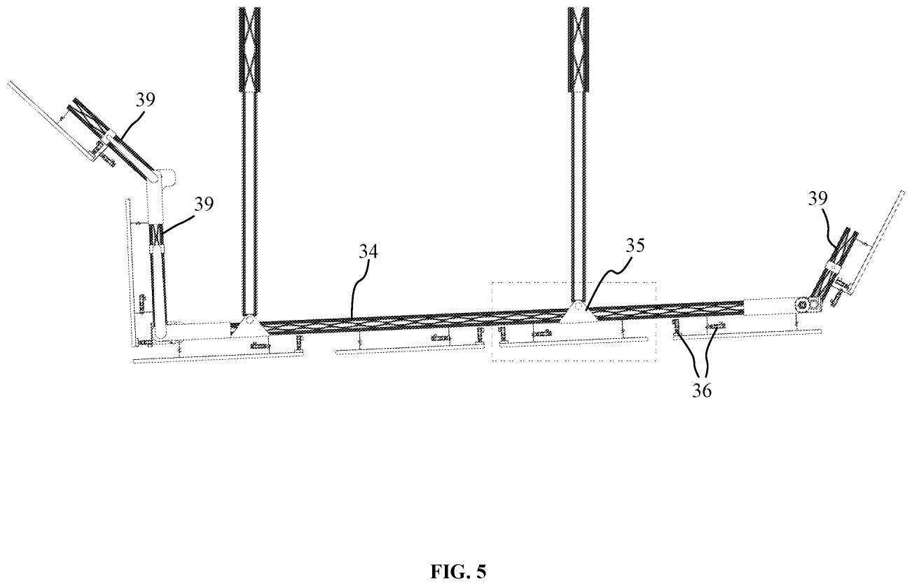

Each frame member typically comprises upper parts 21, 31 and 41 supported by two rails 10. In some embodiments, the base 75 of the hangar 100 may comprise longitudinal drainage gutters 90 adapted to collect used fluids. The said gutters 90 may be connected to one or more reservoirs or tanks 85 to store the used fluids. As shown in FIGS. 2 and 4, the base 75 may further comprise under flush systems 80 to wash the aircraft 50. The base 75 is typically made of concrete or any material supporting the weight of an aircraft. The base 75 typically defines an area for the washing and/or de-icing of an aircraft 50. In some embodiments having no hangar 100, the base may still define an area for the washing and/or de-icing of an aircraft. In such embodiments, the transversal member 34 may be attached to self-supporting structures such as pylons or towers. The pylons or towers are typically spaced apart to let the aircraft 50 move in-between the said self-supporting structures. Understandably, the transversal member 34 are typically attached at a height allowing the aircraft 50 to move under the said transversal members 34. In yet other embodiments, the area for the washing and/or de-icing of the aircraft 50 may be embodied as a platform or a type of area to wash and/or de-ice an aircraft.

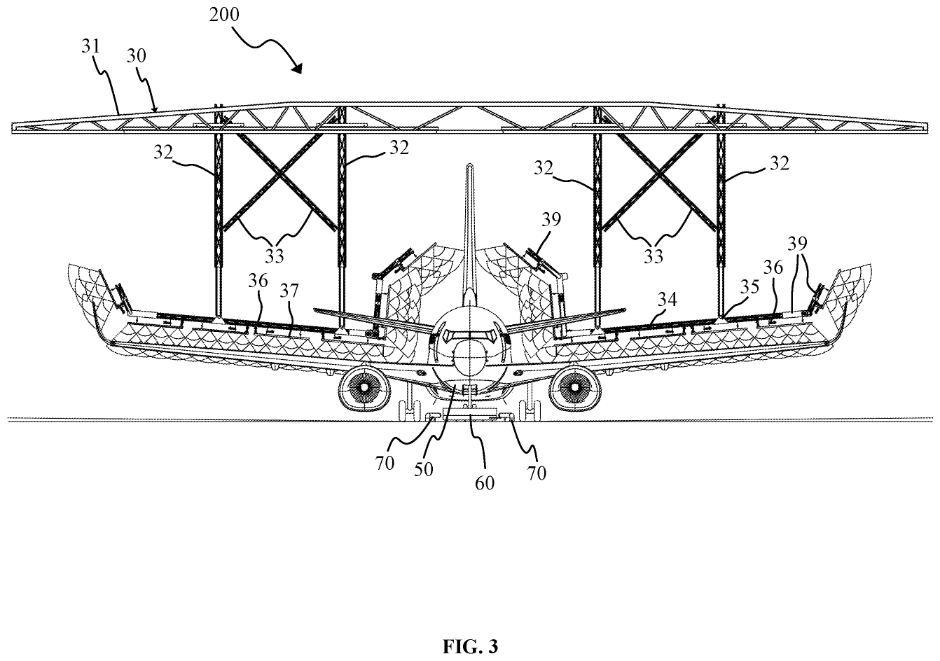

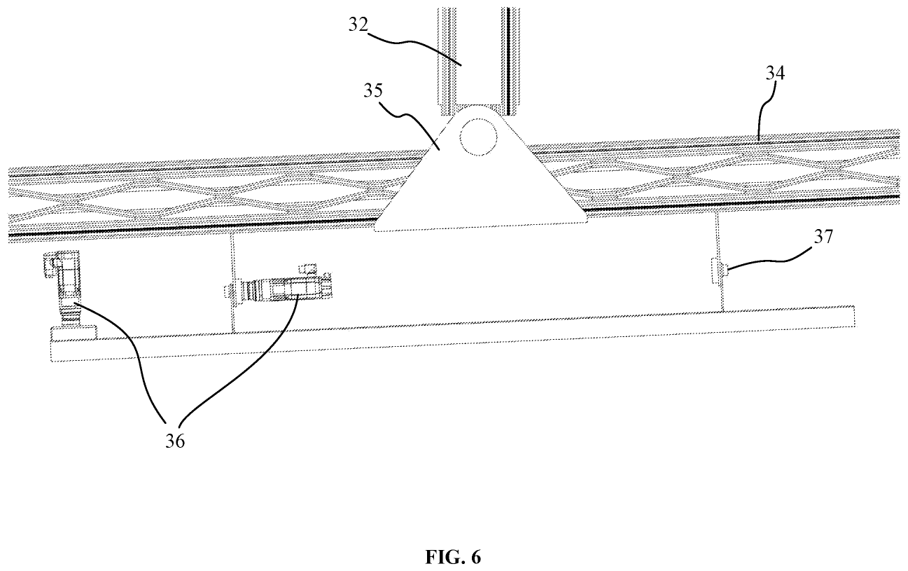

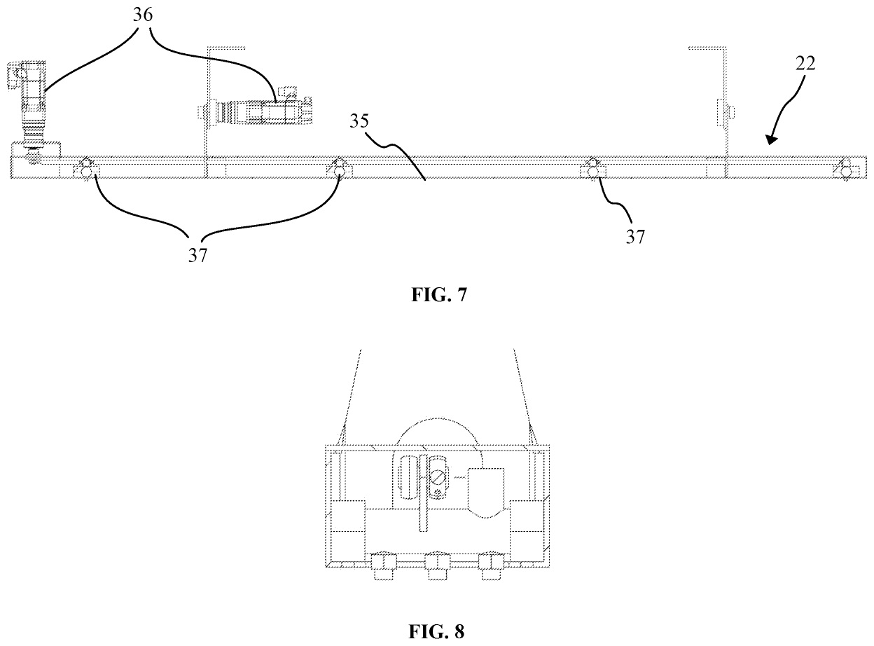

Now referring to FIG. 3, each frame comprises one or more telescopic arm 32 adapted to vertically move a transversal member 34 closer to the aircraft 50. Cross structural elements 33 may be added between two or more telescopic arms 32 to reinforce the assembly, aiming at increasing the stability of the system while moving. The vertical telescopic arms 32 are downwardly attached to the frame 31. A transversal member 34 is attached to two or more telescoping arms 32 as to be maintained close to the aircraft 50. The transversal moving member 34 is typically embodied as a moving telescopic arm 34. The transversal moving member 34 is generally attached to the telescoping arms 32 using any attachment means 35 such as mechanical supports 35 as shown on FIGS. 3 and 6.

Still referring to FIG. 3, in an embodiment having three frames 20, 30 and 40, the central frame or gantry 30 may be adapted to move in-between the two outer frames 20 and 40. In other embodiments, one of the frames 20, 30 and 40 may be adapted to support a cabin 38 adapted to receive an operator. The operator is typically present to control and stop the de-icing and washing process if there is a problem. Understandably and as described in greater detail further below, in other embodiments, the operator may be replaced by a camera and a remote system for controlling and/or stopping the de-icing and washing process.

Each transversal member 34 may comprise different sections 39. Such sections 39 may be adapted to be independently rotating to enable the rotation of different sections of the arm to accommodate different aircraft bodies regardless their sizes. Understandably, any mean known in the art to rotate the different sections 39 may be used.

Now referring to FIG. 7, a flush board 22 comprises one or more fluid spraying means or devices, such as nozzle clusters 37 and engines 36 to rotate nozzle clusters and flush board. The nozzle clusters 37 may comprise any suitable spray nozzle including, but not limited to, flat fan nozzles, hollow cone nozzles, full cone nozzles, misting nozzles and air atomizing nozzles. Understandably, any type of known spaying means or devices may be used with the present invention, such as but not limited to rotary atomizers, nozzles or the likes. Typically, the spraying means are attached to each transversal member 34 in order to spray liquid underneath the transversal member 34 toward the aircraft 50. In a preferred embodiment, the nozzle clusters 37 and engines 36 are adapted to rotate in any direction and to rapidly sweep the surface of the aircraft, back and forth as the aircraft 50 moves under the transversal member or arm 34. The telescopic arms 32 and telescopic transversal member 34 are extended or collapsed using any mean known in the art such as actuators, hydraulic system or electric motors coupled to a gear.

In other embodiments, the transversal member 34, embodied as a telescopic arm, further comprises one or more sections 39, each section 39 being pivotally connected at each end of the transversal member 34. The pivoting sections 39 comprise spray means 36 or 37 adapted to spray the body of the aircraft 50. The pivoting sections 39 are activated using any actuator such as a piston or an electric motor to move the telescopic arm.

In some embodiments, the de-icing system comprises a controller or control system, such as a programmable system to enable a logic controller. In some embodiments, the controller is an automate or a computing device, such as a computer. The controller may be programmed to control individual pressure of each nozzle 37 or each group of nozzles, aiming at accurately controlling the washing process based on the distance from the area to be treated.

The control system may also be configured to synchronize nozzle clusters 37 and telescopic arm 34 and 32 movements. In such an embodiment, the telescopic arm 34 and 32 and the nozzles 37 must be connected to the controller.

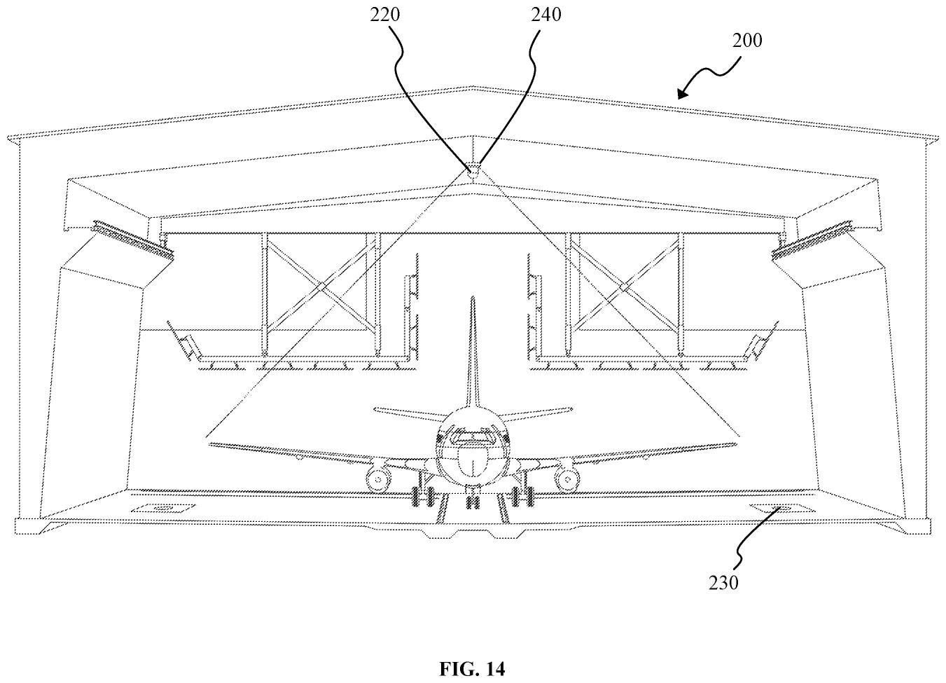

Referring now to FIG. 14, an embodiment of the de-icing and washing system 200 is shown. In such embodiment, the system 200 further comprises one or more position detecting systems 220, also referred as an aircraft position detector. The aircraft position detector 220 is generally configured to identify and/or detect the position of the aircraft 50 within the hangar 100 or within a de-icing and/or washing area. The one or more position detecting systems 220 is typically positioned at a fixed location. In some embodiments, the position detecting system 220 may be affixed to one of the frames 20, 30 and 40, to the roof of the hangar 100, a wall of the hangar 100, to a pole or pillar or to any other suitable surface allowing the position detecting system 220 to detect the aircraft 50 within the hangar 100. In some embodiments, the aircraft position detector 220 is positioned above the aircraft 50 moving on the ground. Preferably, the aircraft position detector 220 is configured to identify the position of the aircraft 50 at a distance, such as over-the-air or wirelessly. In some embodiments, the aircraft position detector 220 uses wave-based technologies or image sensors, such as one or more cameras, to measure and calculate the absolute distance of the aircraft 50.

The one or more position detecting systems 220 may comprise one or more sensors (not shown) suitable for identifying the positioning of an object including, but not limited to, a radar sensor, a LiDAR sensor, an electro-optical sensor, a proximity sensor, a triangulation sensor and a sonar sensor. Configured with one or more of the aforementioned sensors, a position detecting system 220 may determine the position of the aircraft 50 relative to the position of the sensor performing the measurement.

In another embodiment, the position detector 220 comprises one or more three dimensional (3D) scanners. The 3D scanners are generally configured to detect the contours of the aircraft 50 and/or to deduct the position of the aircraft 50 within the hangar 100 or the area for the washing and/or de-icing of an aircraft. In yet other embodiments, the 3D scanner is a laser scanner. In such embodiments, the laser scanner is configured to create a point cloud by scanning many points on the outer surface of the airplane. Understandably, the point cloud may comprise the absolute coordinates of points on the surface of the aircraft 50. In yet other embodiments, the point cloud may comprise points each representing a distance between the scanner and a point on the surface of the aircraft 50. The 3D scanner may further comprise referential points 230 fixed within the hangar 100, the base 75 or the area for the washing and/or de-icing of an aircraft. The 3D scanner is configured to measure and calculate the distance between the 3D scanner and the referential points 230. The 3D scanner further determines the relative distance between the scanner and each point of the point cloud. Based on the calculated distance to the referential points, the scanner may determine or compute the absolute position of the aircraft 50, typically by deduction. As mentioned above, the point cloud may already comprise the absolute position of each point associated with the surface of the aircraft 50. Understandably, the 3D scanner may further be embodied as a sound wave scanner, a radar-based scanner, a photographic or image-based scanner or any other known 3D scanner to detect the distance and/or contour of large objects, such as aircraft or other vehicles.

It may be appreciated that the position of the sensor may vary as the structure supporting the position detecting system 220 is moved either intentionally (as may be the case with the transverse frame member 30) or unintentionally (as may be the case with the roof or a wall of the hangar 100 as it is subjected to environmental or other forces). To that end, the de-icing and washing system 200 may further comprise one or more static reference points 230 wherein each reference point 230 defines a fixed location within the hangar 100. In a preferred embodiment, the static reference points 230 may be affixed to a fixed or static element of the hangar 100 such as, for example, the base 75 while remaining visible to the sensor of the one or more position detecting systems 220. In certain embodiments, the reference points 230 may comprise a metallic plate, a tag, a printed pattern, a light emitting diode or any other suitable element identifiable by a sensor. By the principles of triangulation, the position detecting system 220 may therefore identify its own position within the hangar 100 thereby allowing it to identify an absolute position of the aircraft 50 within the hangar 100.

In some embodiments, the position detecting system 220 comprises measuring the distance between the said position detecting system 220 and the reference points 230 and measuring the distance between the said position detecting system 220 and a specific point on the surface of the aircraft 50. Using the two measurements, the system may calculate or compute the absolute position of the said specific point of the aircraft 50. The process is repeated at a fixed frequency to create the cloud of points, each point typically having an absolute position. The cloud of points may be used to determine the position of the aircraft 50 and/or the shape and dimensions of the aircraft 50.

In certain embodiments, the de-icing and washing system 200 may further comprise one or more shape detecting systems 240, also referred to an aircraft contour detector, aircraft shape recognition system or aircraft dimension detector, configured to identify a shape of the aircraft 50. More specifically, the one or more shape detecting systems 240 may be configured to allow de-icing and washing system 200 to automatically determine various dimensions of the aircraft 50 including, but not limited to, its height, length, wingspan as well as the shape of fuselage and wings of the aircraft 50.

The one or more shape detecting systems 240 may similarly be affixed to one of the transverse frame members 20, 30 and 40, to the roof of the hangar 100, a wall of the hangar 100 or any other suitable surface allowing the position detecting system 220 to detect the aircraft 50 within the hangar 100. Preferably, the shape detecting system 240 is configured to identify the contour of the aircraft 50 at a distance, such as over-the-air or wirelessly. In some embodiments, the shape detecting system 240 uses wave-based technologies or image sensors, such as one or more cameras, to measure and calculate the absolute distance of the aircraft 50.

The one or more shape detecting systems 240 may comprise one or more sensors (not shown) suitable for identifying the positioning of an object including, but not limited to, a radar sensor, a LiDAR sensor, an electro-optical sensor, a proximity sensor, a triangulation sensor and a sonar sensor.

In certain embodiments, one or more sensors of the shape detecting system 240 may additionally be configured to detect properties of the surface of the aircraft such as, for example, whether the surface is wet thereby indicating that it has been washed and/or de-iced. In other embodiments still, one or more sensors of the shape detecting system 240 may identify irregularities along the surface of the aircraft 50 which may indicate the need for servicing or damage to the aircraft.

In certain embodiments and as shown in the embodiment illustrated in FIG. 14, a position detecting system 220 and shape detecting system 240 may form a unitary device configured to identify the position and the shape of the aircraft 50. In other words, the position detecting system 220 and shape detecting system 240 may form a single general aircraft detection system. In such embodiments, the position detector 220 and the contour detector 240 are embodied as a 3D scanner, such as but not limited to a 3D laser scanner device, as described above.

The de-icing and washing system 200 may utilize both the one or more position detecting systems 220 and the one or more shape detecting systems 240 to perform measurements along different points on the surface of the aircraft 50 thereby creating a point cloud representation of the aircraft 50 with a higher number of measured points offering a higher resolution three-dimensional representation of the aircraft 50.

In embodiments wherein the aircraft detection system comprises a 3D laser scanner, the laser scanner may comprise any suitable projector such as a rapidly pulsating or continuous laser being steered by one-dimensional or two-dimensional moveable mirrors. The laser scanner may further comprise any suitable camera such as a laser rangefinder or laser telemeter comprising any suitable sensor for capturing light refracted from the surface of the aircraft 50. In this manner, the 3D scanner is configured to determine the distance of the 3D scanner to the aircraft 50 thereby creating dimensional data regarding a dimension of the aircraft.

In certain embodiments, the aircraft detection system may additionally comprise an RGB sensor configured to capture photographic images of the aircraft 50 allowing the 3D scanner to associate colors to the point cloud representation generated by the laser scanner.

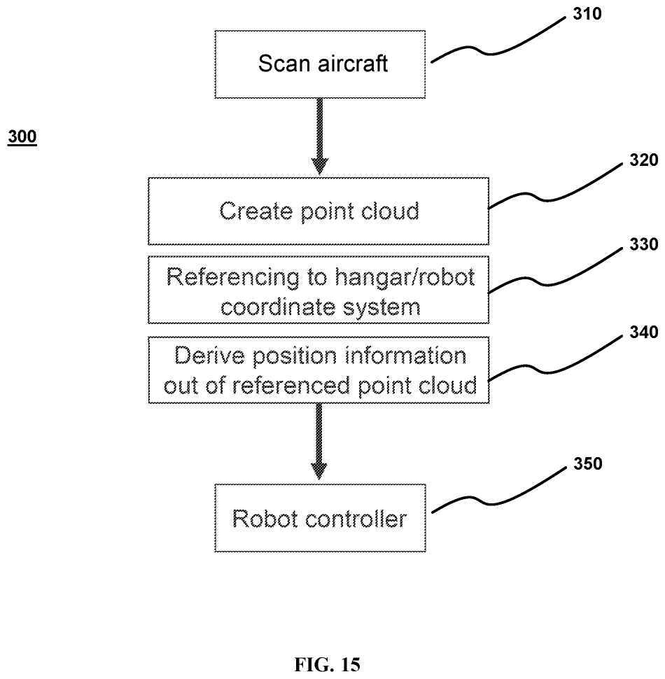

Referring now to FIG. 15, a method 300 for determining a position of the aircraft 50 is illustrated. The method 300 may comprise a first step 310 of scanning the aircraft 50 with the position detecting system 220 and the shape detecting system 240. The method 300 may further comprise a step 320 of creating a point cloud representation of the aircraft 50 and a step 330 comprising referencing the measurements to a reference coordinate system of the hangar 100. The method may further comprise the step 340 of deriving an absolute position of the aircraft 50 within the hangar 100. Finally, step 350 of the method may comprise transmitting said absolute position and shape of the aircraft 50 the controller.

In a preferred embodiment, the controller may be in communication with the one or more position detecting systems 220 and the one or more shape detecting systems 240 thereby allowing the controller to synchronize the movement of the telescopic arms 32 and 34 of the frames 20, 30 and 40 with the position and the shape of the aircraft 50. The program enabling synchronization may therefore take into account the aforementioned measured properties of the aircraft 50 as well as its position within the hangar 100

In yet other embodiments, the properties of the aircraft 50 may be communicated to the controller or accessible to the controller, such as through a data source or database. The predetermined parameters may be the dimension of the aircraft, the wingspan, and the shape of the aircraft, the outside/inside environmental and atmospheric conditions or any other relevant parameter.

The controller may be embodied as any computerized device, any programmable controller or any type of computer system as known in the art. Understandably, the controller may be unitary or be in communication with any module or subsystem of the system for washing and/or de-icing 200. In some embodiments, the controller may be unitary with the position detector 220, the contour detector 240 or the aircraft pulling system 60. Understandably, any type known control systems or controllers are within the scope of the present invention.

In a preferred embodiment, one or more frames 20, 30 and 40 comprise one or more sensors or electro-mechanical sensors, such as, but not limited to a proximity sensor. The sensors may, for instance, be configured to send a signal when a portion of the airplane 50 is within a predetermined distance of the sensor. Upon receiving such signal, the controller request that the transversal member 34 or telescopic arms 32 be repositioned to avoid touching the aircraft.

Referring back to the FIG. 2, the aircraft 50 is shown inside the hangar 100. In a preferred embodiment, the aircraft 50 is guided along the roadway using an aircraft pulling system 60, such as but not limited to a spacer unit, a tractor, a towbar, a cable system or any other suitable means for pulling an aircraft. In other embodiments, the aircraft 50 is guided along the roadway using an aircraft pushing system (not shown) such as, but not limited to a pushback tractor, a towbar, a cable system, or any other suitable means for pushing an aircraft. Such aircraft pulling system 60 may configured to be in communication with the controller in order to control the movement of the aircraft 50 during the de-icing/washing process. The aircraft pulling system 60 may be driven by an operator, may be autonomous or radio-controlled, or may run between two guiding rails 70 fixed to the base 75 of the hangar 100. The aircraft pulling system 60 aims at substantially maintaining the aircraft within a predetermined path. In embodiments where the aircraft pulling system 60 is equipped with a position detection system, the pulling system 60 is configured to continuously communicate the position of the aircraft 50 to the controller.

In other embodiments, the position of the aircraft pulling system 60 or of the aircraft 50 may be determined using any position detecting system or detectors, such as any proximity sensor attached to the hangar 100, along the path of the aircraft 50, on the aircraft pulling system 60 or any other method to identify the position of the aircraft pulling system 60 or of the aircraft 50, such as a precise GPS unit or any other position measurement system. In some embodiments, a GPS unit may be installed in the aircraft pulling system 60 or directly in the aircraft 50. The aircraft 50, the pulling system 60 and/or the GPS unit may be configured to communicate the detected coordinates to the controller. In yet other embodiments, the position of the aircraft pulling system 60 may be determined using a mechanical system with cables. In other embodiments, the aircraft 50 may taxi itself within the hangar 100 or within the area of de-icing and washing of the aircraft 50.

In a preferred embodiment, the fluid stored in tanks 85 is re-circulated to a common manifold. The manifold is configured to adjust the concentration of the used fluid with regard to the weather conditions by adding glycol or heated water. The manifold may be in communication with the controller and adapted to adjust the concentration of fluid based a signal received from the controller. The controller may generate the signal based on the environmental conditions provided to the controller either manually or through sensors. The environmental conditions may be provided to the controller using any sensor such as electro-thermometer, barometer, wind speed sensor, etc.

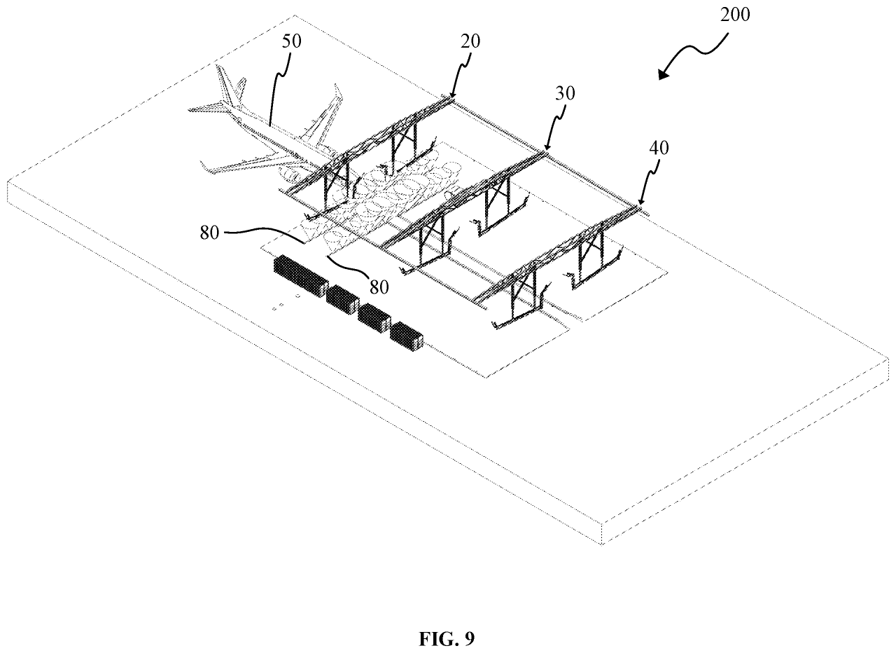

Now referring to FIGS. 9 to 13, a method for washing and/or de-icing aircrafts is shown. The method generally comprises the steps for the aircraft to be moved within the hangar 100 or within the de-icing and/or washing area. As described above, the aircraft 50 may taxi itself or be moved using any type of aircraft moving device, such as an aircraft pulling system 60. In embodiments using an aircraft pulling system 60, the method may further comprise attaching the aircraft to the aircraft pulling system 60. The method further comprises detecting and/or determining the position of the aircraft within the hangar 100 or within the de-icing and/or washing. The method further comprises communicating the airplane 50 detected position to the washing and/or de-icing system. The method may further comprise detecting the contour, shape and/or dimensions of the aircraft 50. In such embodiments, the method may further comprise communicating the airplane 50 detected contours, shapes and/or dimensions to the washing and/or de-icing system. In another embodiment, the specification of the aircraft could be fetched from a database or data store being either local or remote comprising specifications of most or all the aircraft upon identifying the type and model of aircraft or upon receiving the type and model of the aircraft 50. The method further comprises synchronously positioning at least one automated vertical elongated member based on the detected position and on the detected contour of the aircraft and activating the spraying system upon positioning of the automated vertical elongated member.

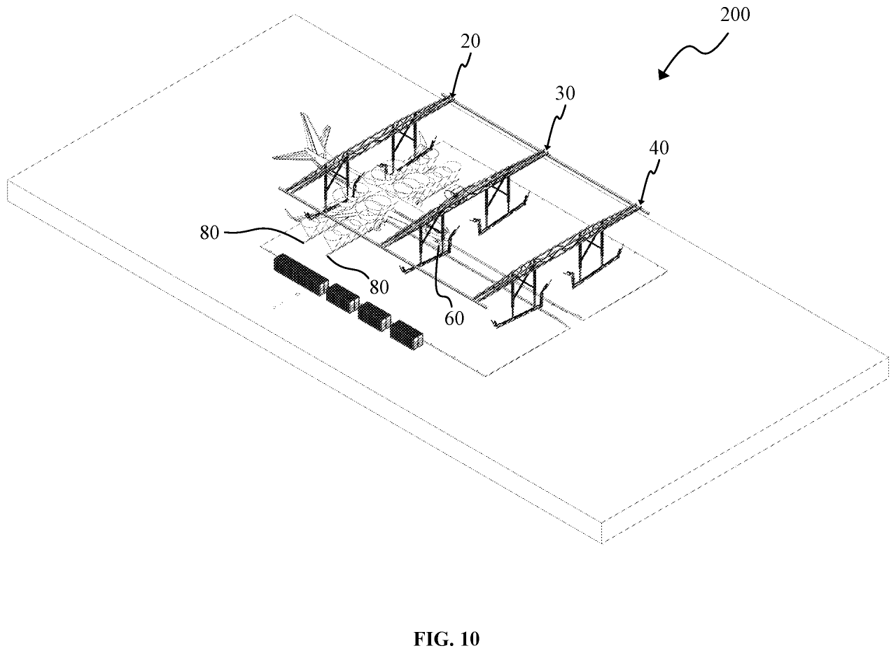

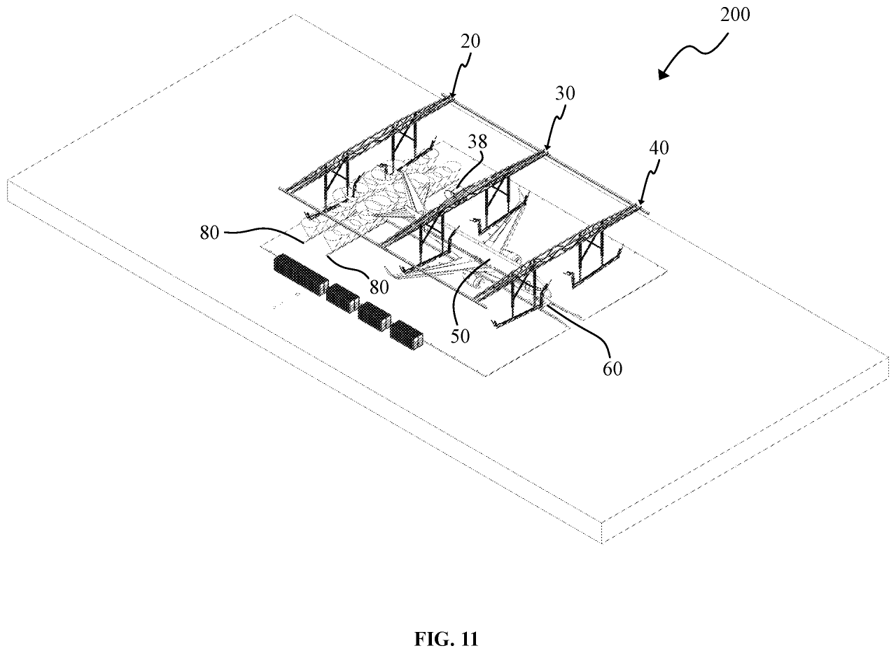

In some embodiments, the method further comprises moving at least the first vertical telescoping arms 32 at a height in accordance with the airplane 50 specifications and aiming at limiting the distance between the spray means and the aircraft 50 body. As the aircraft 50 moves towards the first frame 20, the spray means 36 and/or 37 of the transversal member 34 are activated based on the detected position of the aircraft 50. Spray means 80, typically providing an under flush of the aircraft 50, at the base 75 are typically only open during the washing process (see FIGS. 9 and 10). As the aircraft 50 moves toward the third frame 30 which comprises a second set of spray means, the second set of spray means are activated (see FIG. 11—not showing activation of the spray means for clarity purposes) during the washing process.

When the system is used as a de-icing system, in an embodiment having at least three frames, as the aircraft 50 moves toward the second frame 30, a quality check is typically executed, preferably by an operator using the movable frame 30 to move above the whole plane along the length of the aircraft. In other embodiments, sensors or any mean for controlling surface quality may be used instead of an operator. As the plane approaches the third frame 40, the spray means 36 and/or 37 of the transversal member 34 are activated to apply a final treatment either polishing when the system is used as a washing system or anti-icing treatment when the system is used as a de-icing system. As the plane 50 moves away from any of the first 20, second 30 or third 40 frames, the first, second and/or third set of spray means are respectively stopped or deactivated.

The present embodiment is shown with a hangar 100 comprising 3 frames 20, 30 and 40. Understandably, the hangar 100 could be adapted to use one or two frames or more than 3 frames without departing from the principles of the present invention.

In an embodiment having an operator, for both washing and de-icing, once the aircraft approaches the hangar 100, as shown on FIG. 9, the operator establishes communication with the aircraft, typically using a radio or any other mean of communication. During the communication, the conditions of the process are defined, and the control system is configured to the airplane specifications. The aircraft 50 may be moving within the washing and de-icing area, such as moving attached to the pulling system 60.

In other embodiments, the communication between the controller and the other systems, such as the position detector, the contour detector and/or the aircraft 50 may be automated using any type of known data or analogic communication protocol over a network, such as LAN network, wireless communication, etc.

In a typical process of washing and/or de-icing, the plane moves, a first time, through all the way from the frame 20 to the frame 40 to be first washed and rinsed, then a second time to be de-iced. Understandably, other steps may be inserted in-between the present steps without departing from the present invention.

Once inside the hanger 100, as shown on FIG. 10, the aircraft pulling system 60, illustrated as a spacer unit, which may be running between the two guiding rails, communicates the position of the plane to the control system using any type of communication mean, such as wireless communication or wired communication. The control system is configured to control the movement and the function of nozzle clusters 37 on the frame 20 during the washing process or the de-icing process. Typically, the under flush system 80 is activated to apply foam to the underside of the aircraft 50 while the plane 50 moves by the first frame 20.

In yet other embodiments, as discussed above, the position of the aircraft may be determined using any type of sensor, such as a 3D scanner. In such embodiments, the sensor is configured to communicate the detected position of the airplane to a controller. The controller is configured to automatically synchronize the movement of the automated vertical elongated member to conform to the shape and dimensions of the aircraft and/or with the detected position of the aircraft 50. The controller is typically further configured to automatically activate the spraying system up positioning of the automated vertical elongated member.

Now referring to FIG. 11, the aircraft 50 is shown being washed. During the washing process and as the aircraft 50 moves toward the second frame 30, the under flush system 80 under the frame 30 is activated to remove the washing foam on both the upper side and underside of the aircraft 50. The aircraft 50 is fully flushed with hot water using the spray means. Typically, during the de-icing process, as the aircraft 50 moves under the second frame 30, a manual quality check is executed by the operator using the mobile gantry 30.

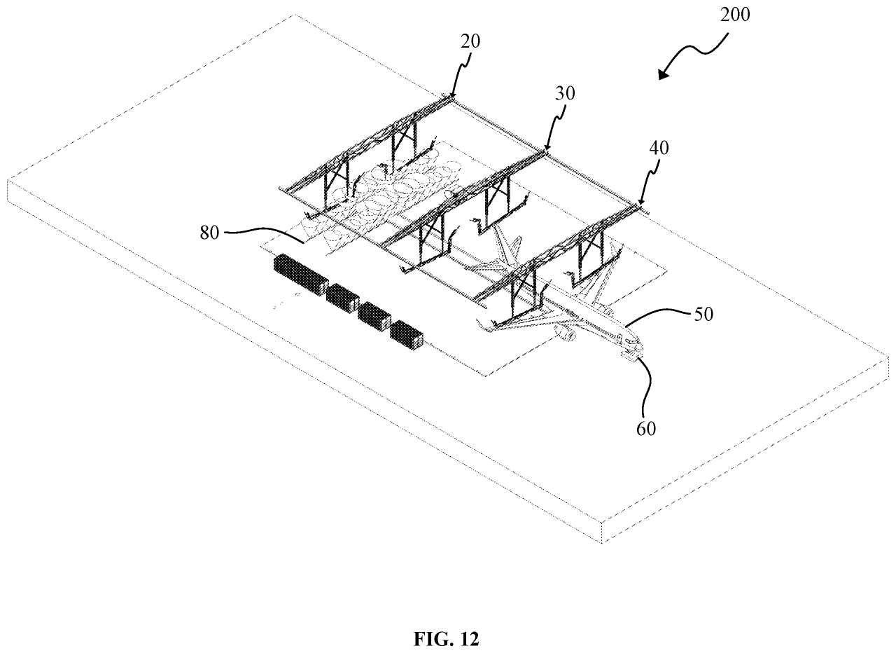

Now referring to FIG. 12 and during the washing process, once the aircraft reaches the third frame 40, another fluid, such as but not limited to a polish liquid, is applied to the aircraft 50. However, during the de-icing process an anti-ice liquid, typically 100% Glycol, is applied to the aircraft.

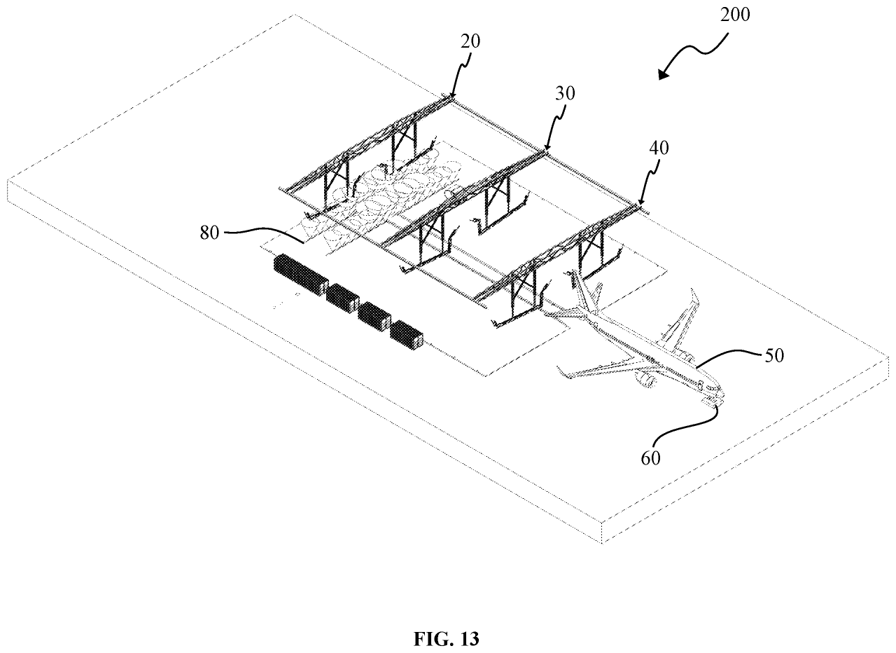

As shown on FIG. 13, once the washing process or the de-icing process is completed, the exemplary aircraft pulling system 60 pulls the aircraft about 90 degrees before being disconnected.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

What is claimed is:

1. A system for washing and de-icing an aircraft, the system comprising:
a washing and de-icing area;
at least one transversal frame, each transversal frame comprising at least one automated vertical elongated member adapted to move vertically, each vertical elongated member being connected to a transversal member;
a spraying system comprising at least one nozzle, the spraying system being attached to the at least one transversal member and adapted to disperse liquid below the transversal member;
an over-the-air aircraft position detector to determine the position of the aircraft anywhere in the washing and de-icing area;
an aircraft contour detector configured to identify the shape and dimensions of the aircraft;
a controller in communication with the aircraft position detector and with the aircraft contour detector, the controller being programmed to:
receive the detected position of the aircraft and the detected shape and dimensions information of the aircraft;
control movement of the at least one automated vertical elongated member and to control activation of the spraying system, wherein the controller uses the received detected position of the aircraft and the detected shape and dimensions of the aircraft to:
automatically synchronize the movement of the automated vertical elongated member to conform with the shape and dimensions of the aircraft; and
automatically activate the spraying system up positioning of the automated vertical elongated member.

2. The system for washing and de-icing an aircraft of claim 1, wherein the system comprises at least one static reference point fixed at a predetermined location in the washing and de-icing area, the static reference point being detectable by the aircraft position detector.

3. The system for washing and de-icing an aircraft of claim 2, the aircraft position detector being configured to detect the position of the at least one static reference point in relation to the aircraft position detector.

4. The system for washing and de-icing an aircraft of claim 1, the aircraft position detector comprising one or more laser scanners.

5. The system for washing and de-icing an aircraft of claim 4, the one or more laser scanners being fixed to be positioned over the aircraft.

6. The system for washing and de-icing an aircraft of claim 1, wherein the aircraft contour detector comprises one or more laser scanners.

7. The system for washing and de-icing an aircraft of claim 1, wherein the aircraft position detector and the aircraft contour detector are unitary.

8. The system for washing and de-icing an aircraft of claim 1, wherein at least one of the aircraft position detector and the aircraft shape detector are affixed to the washing and de-icing area.

9. The system for washing and de-icing an aircraft of claim 1, the system further comprising a hangar having a base, the washing and de-icing area being within the hangar.

10. A system for washing and de-icing an aircraft, the system comprising:
a washing and de-icing area;
at least one transversal frame, each transversal frame comprising at least one automated vertical elongated member adapted to move vertically, each vertical elongated member being connected to a transversal member;
a spraying system comprising at least one nozzle, the spraying system being attached to the at least one transversal member and adapted to disperse liquid below the transversal member;
a three-dimensional (3D) aircraft scanner within a line of sight of the aircraft, the aircraft scanner being configured to identify a position of the aircraft anywhere in the washing and de-icing area;
a controller in communication with the aircraft scanner being programmed to:
receive the detected position of the aircraft from the aircraft scanner;
control movement of the at least one automated vertical elongated member and to control activation of the spraying system;
using the received position of the aircraft and shape and dimensions of the aircraft to:
automatically synchronize the movement of the automated vertical elongated member to conform with the shape and dimensions of the aircraft; and
automatically activate the spraying system up positioning of the automated vertical elongated member.

11. The system for washing and de-icing an aircraft of claim 10, wherein the aircraft scanner is a laser scanner.

12. The system for washing and de-icing an aircraft of claim 10, wherein the system comprises at least one static reference point fixed at a predetermined location in the washing and de-icing area, the static reference point being detectable by the aircraft scanner.

13. The system for washing and de-icing an aircraft of claim 12, the aircraft scanner being configured to detect the position of the at least one static reference point in relation to the aircraft scanner.

14. The system for washing and de-icing an aircraft of claim 10, the aircraft scanner being further configured to determine a height, length and wingspan of the aircraft.

15. The system for washing and de-icing an aircraft of claim 10, the system further comprising a hangar having a base, the washing and de-icing area being within the hangar.

16. A method for washing and de-icing an aircraft, the method comprising:
moving the aircraft within a washing and de-icing area;
automatically detecting a position of the aircraft within the washing and de-icing area;
automatically detecting a contour of the aircraft present in the washing and de-icing area;
synchronously positioning at least one automated vertical elongated member based on the detected position and on the detected contour of the aircraft;
activating a spraying system upon positioning of the at least one automated vertical elongated member.

17. The method of claim 16, automatically detecting the position of the aircraft comprising scanning the aircraft to obtain a three-dimensional map of the aircraft.

18. The method of claim 17, obtaining the three-dimensional map of the aircraft comprising:
creating a point cloud of the aircraft;
calculating reference values of the point cloud in a coordinate system of the washing and de-icing area;
deriving the position of the aircraft using the reference values.

19. The method of claim 18, the calculation of the reference values comprising determining relative position of a scanning device to fixed reference points in the washing and de-icing area.
